(19) United States
(12) Patent Application Publication
(10) Pub. No.: US 2017/0265671 A1
(43) Pub. Date: Sep. 21, 2017

(54) SAUCEPAN

(71) Applicant: KE M.O. HOUSE CO., LTD., Guangdong (CN)

(72) Inventor: MO-TSAN TSAI, Guangdong (CN)

(21) Appl. No.: 15/136,758

(22) Filed: Apr. 22, 2016

(30) Foreign Application Priority Data
Mar. 18, 2016 (CN) 201620211603.0

(51) Int. Cl. A47J 27/00; A47J 36/02

(52) U.S. Cl. CPC A47J 27/002; A47J 36/02; A47J 36/025

(57) ABSTRACT

A saucepan is provided, which includes a saucepan body (1) and a handle (2) fixedly attached to the saucepan body (1). The saucepan body (1) includes a bottom (10) and four sidewalls surrounding the bottom (10). The sidewalls (11) are arcuate surface. The sidewalls (11) are connected with the bottom (10) through fillets. The sidewalls of the saucepans according to the embodiments of the present disclosure are designed as arcuate surface. Therefore, the capacity of the saucepans is increased, and the food in the saucepans is easy to be gathered and thus easy to be transferred into tableware. The convenience of use is improved.

### TECHNICAL FIELD

The present disclosure relates to kitchenware, in particular to saucepans.

### BACKGROUND

An existing square-plate type saucepan mainly includes a bottom and four sidewalls. The sidewalls are flat plates which are tilted certain angles with respect to the bottom. This type of saucepan has low capacity and can accommodate less food ingredients, which is very inconvenient for the user.

### SUMMARY

A saucepan is provided, which may include a saucepan body and a handle fixedly attached to the saucepan body. The saucepan body may include a bottom and four sidewalls surrounding the bottom. The sidewalls may be arcuate surface. The sidewalls may be connected with the bottom through fillets.

The sidewalls of the saucepans according to the embodiments of the present disclosure are designed as arcuate surface. Therefore, the capacity of the saucepans is increased, and the food in the saucepans is easy to be gathered and thus easy to be transferred into tableware. The convenience of use is improved.

### BRIEF DESCRIPTION OF DRAWINGS

FIG. 1 is a schematic view showing the overall construction of a saucepan according to an embodiment;

FIG. 2 is a top view of the saucepan body according to an embodiment; and

FIG. 3 is a section view taken along line A-A in FIG. 2.

### DETAILED DESCRIPTION

The present disclosure will be described in details with reference to specific embodiments in connection with the drawings.

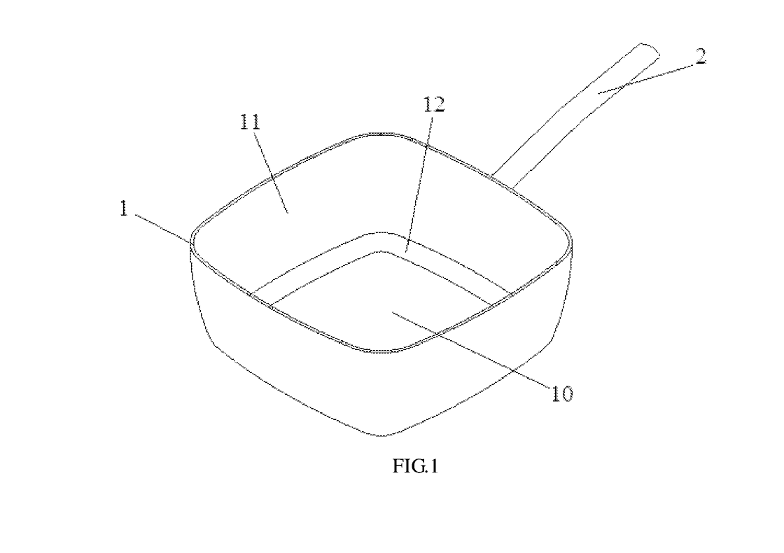

A saucepan may be provided by the present disclosure. As shown in FIG. 1 and FIG. 3, in some embodiments, the saucepan may include a saucepan body 1 and a handle 2 which is fixedly attached to the saucepan body 1. The handle 2 may be riveted to the saucepan body 1 by a cold insert riveting process. The saucepan body 1 may include a bottom 10 and four sidewalls 11. The sidewalls 11 surround the bottom 10 and have the same shape and size. The surface of an individual sidewall may be an arcuate surface. The sidewalls 11 may be connected with the bottom 10 through fillets 12. Furthermore, two adjacent sidewalls may also be connected with each other through an additional fillet. The saucepan body 1 may be made of aluminum sheet.

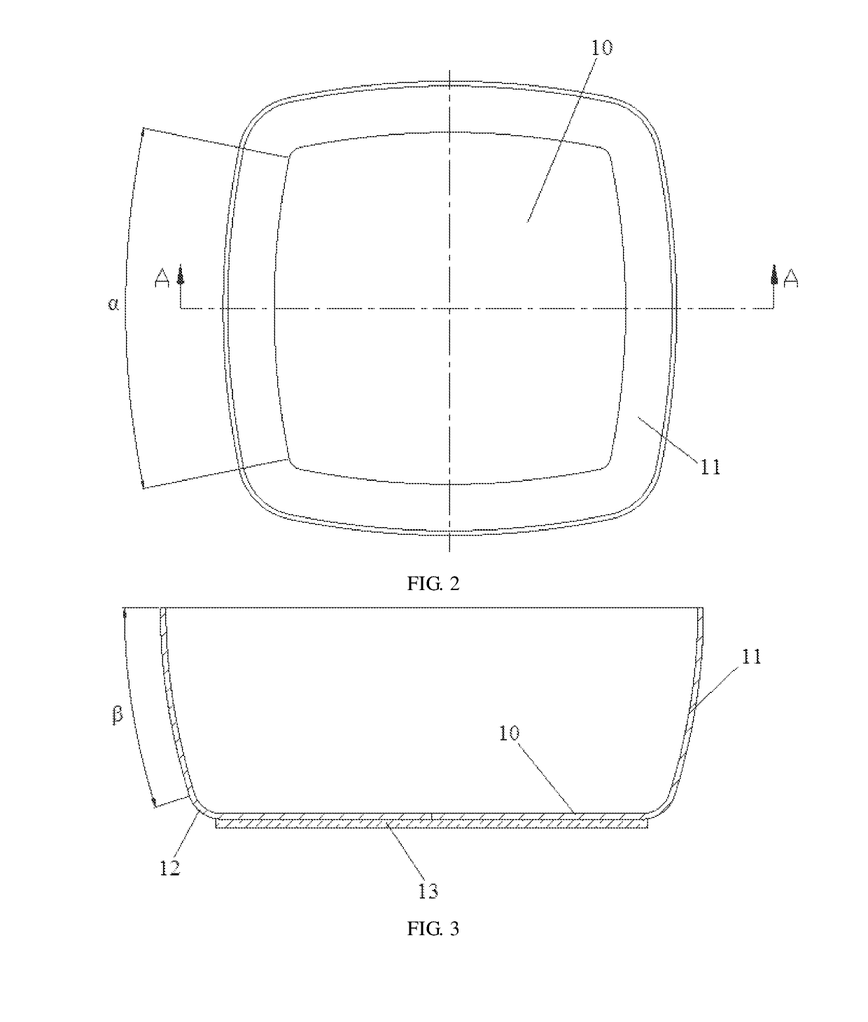

Further, as shown in FIG. 2, a lateral radian (i.e., the radian in a direction parallel to the bottom 10) of an individual sidewall 11 is α, and α may be within a range from 0.3 rad to 0.5 rad. A longitudinal radian (i.e., the radian in a direction perpendicular to the bottom 10) of an individual sidewall 11 is β, and β may be within a range from 0.2 rad to 0.5 rad. In the shown embodiment, the lateral radian α of the sidewall is 0.4 rad, and the longitudinal radian β is 0.44 rad.

In another embodiment, the lateral radian α of the sidewall may be 0.4 rad, and the longitudinal radian β may be 0.31 rad.

The capacity of, and the distance between the sidewalls 11 and the bottom 10 of, the saucepan according to the embodiments of the present disclosure can be changed by adjusting the value of the longitudinal radian β, and thereby the saucepan can be suitable for different cooking. For example, in embodiments in which the distance between the top of the saucepan and the bottom 10 is small, the saucepan can be used as a frying pan; in embodiments in which the distance between the top of the saucepan and the bottom 10 is large, the saucepan can be more suitable for being used as a stockpot.

As shown in FIG. 3, the outer surface of the bottom 10 may further be provided with a stainless steel second bottom 13. The second bottom 13 may be riveted to the bottom 10 by a cold insert riveting process. Due to the arrangement of the second bottom 13, the saucepan can be used not only in fire cooking, but also on induction cookers. The inner surface of the saucepan body 1 may further be provided with a ceramic release layer. The outer surface of the saucepan body 1 may be applied with anti-high temperature protective lacquer.

The sidewalls of the saucepans according to the embodiments of the present disclosure are designed as arcuate surfaces. Therefore, the capacity of the saucepans is increased, and the food in the saucepans is easy to be gathered and thus easy to be transferred into tableware. The convenience of use is improved.

Detailed description of the present disclosure has been made hereinabove with reference to the specific embodiments. However, it should not be interpreted as that the embodiments of the present disclosure are limited to the description. Many modifications or alternatives can be made by person ordinarily skilled in the art without departing from the concepts of the present disclosure.

1. A saucepan, comprising a saucepan body and a handle which is fixedly attached to the saucepan body, wherein the saucepan body comprises a bottom and four sidewalls surrounding the bottom, the sidewalls are arcuate surface, and the sidewalls are connected with the bottom through fillets.

2. The saucepan of claim 1, wherein a lateral radian of an individual sidewall is within a range from 0.3 rad to 0.5 rad, and a longitudinal radian of an individual sidewall is within a range from 0.2 rad to 0.5 rad.

3. The saucepan of claim 2, wherein two adjacent sidewalls are connected with each other through a fillet.

4. The saucepan of claim 1, wherein the saucepan body is made of aluminum.

5. The saucepan of claim 1, wherein an outer surface of the bottom is provided with a stainless steel second bottom.

6. The saucepan of claim 1, wherein the stainless steel second bottom is riveted to the outer surface of the bottom by a cold insert riveting process.

7. The saucepan of claim 1, wherein the handle is riveted to the saucepan body.

8. The saucepan of claim 7, wherein an inner surface of the saucepan body is provided with a ceramic release layer and an outer surface of the saucepan body is applied with anti-high temperature protective lacquer.
